(19) United States
(12) Patent Application Publication
(10) Pub. No.: US 2012/0281395 A1
(43) Pub. Date: Nov. 8, 2012

(54) MULTIFUNCTIONAL PAINTBALL GUN BARREL PLUG STRUCTURE

(76) Inventor: CHAO I-TE, Taipei County (TW)

(21) Appl. No.: 13/082,416

(22) Filed: May 6, 2011

(51) Int. Cl. F21L 4/00; A24F 13/12; F41B 11/34

(52) U.S. Cl. 362/190; 124/80; 131/178

(57) ABSTRACT

This invention relates to a multifunctional paintball gun barrel plug structure, comprising: a barrel plug, wherein the body of the barrel plug is equipped with bores at its axial and radial sides, with a plug included at the body end and having at least an O-ring slot at the upper ring of the plug, and also a nozzle is included next to the plug, in which a connecting channel exists between the nozzle and the bore on the radial side of the body; an optional tobacco pipe which is installable to the body and equipped with a chamber, wherein a stud beneath the tobacco pipe and within the radial side bore connects the chamber and bore; an optional tobacco can at the axial side of the body comprising a lower base, a cover, and an O-ring, which the O-ring is between the lower base and cover above, and the cover end equipped with a stud corresponding to the bore at the axial side of the barrel plug; an optional flashlight at the axial or radial side of the body, which includes a lamp holder and base, wherein the flashlight includes a lamp holder and base. The lamp holder is installed on the base, in which the base end is equipped with a stud corresponding to the barrel plug bore on the axial or radial side. With this design, the invention not only functions as a safety plug for the paintball gun barrel, but also capable to function as a tobacco can, tobacco pipe and flashlight. The present invention effectively enhances the scope of application and convenience.

### SUMMARY OF THE INVENTION

The purpose of this present invention is to provide an improved display structure to overcome the difficulties with the current technology.

The issue solved in this invention is that the bung size of plug must completely fit with the bore size of the barrel for the presently available barrel plug. Any error is the diameter size (too big or too small) of the paintball gun barrel shall result of unfitting of the barrel for a large plug, or loosening for a small plug. Furthermore, the presently available barrel plug has a poor structural design which has only a single purpose for plugging the paintball gun barrel. As it is unable for other purposes, it can be only discarded as waste when not used. The narrow scope of application therefore does not meet with practicable use.

To achieve the above goal, the present invention provides a multifunctional paintball gun barrel plug structure, comprising:

A barrel plug, wherein the body of the barrel plug is equipped with bores at its axial and radial sides, with a plug included at the body end and having at least an O-ring slot at the upper ring of the plug, and also a nozzle is included next to the plug, in which a connecting channel exists between the nozzle and the bore on the radial side of the body.

Preferably, the barrel plug nozzle of the invention can form a conical shape.

Still more preferably, at the bore on the radial side of the barrel plug body includes an optional tobacco pipe, with said tobacco pipe is installable to the body and equipped with a chamber, wherein a stud beneath the tobacco pipe and within the radial side bore connects the chamber and bore.

Preferably, the tobacco pipe chamber in this invention forms a U-shape.

Still more preferably, an optional tobacco can at the axial side of the body comprising a lower base, a cover, and an O-ring, which the O-ring is between the lower base and cover above, and the cover end equipped with a stud corresponding to the bore at the axial side of the barrel plug.

Preferably, the tobacco can cover of this invention is equipped with internal thread, wherein a chamber is included at the lower base, and a protruding outer thread is included at the end in correspondence to the cover's internal thread. Furthermore, an O-ring is placed at the bottom of the outer thread and closely attached to the corresponding cover.

Still more preferably, the invention includes an optional flashlight at the axial or radial side of the body, which includes a lamp holder and base, wherein the flashlight includes a lamp holder and base. The lamp holder is installed on the base, in which the base end is equipped with a stud corresponding to the barrel plug bore on the axial or radial side.

Preferably, the flashlight holder of the invention is included with a lamp inside, and with internal thread at one end. Furthermore, beneath the lamp holder is a chamber base, wherein the internal threads of the base and lamp holder match together, and the protruding outer thread is located at the corresponding end. Inside the chamber is a spring switch and battery to provide electricity to the lamp.

The design of the present invention not only functions as a safety plug for the paintball gun barrel, but also functions as a tobacco can to place tobacco, and also works as a tobacco pipe and flashlight. The invention can effectively broaden the scope of application and increase its convenience, which displays improvement, practical use, and meets with the needs of users.

### BRIEF DESCRIPTION OF THE DRAWINGS

FIG. 1 is an exploded view of a presently available plug and barrel.

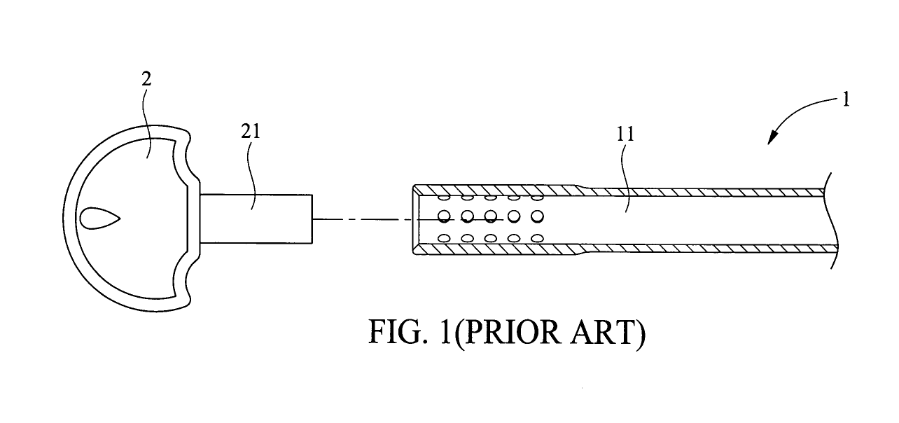

FIG. 2 is a structural assembly drawing of the present plug invention attached to the barrel.

FIG. 3 is an exploded view of the present invention.

FIG. 4 is a structural assembly drawing of the present plug invention attached with a tobacco pipe and tobacco can.

FIG. 5 is a structural assembly drawing of the present plug invention attached with a tobacco pipe and tobacco can.

FIG. 6 is an assembly section drawing of the present plug invention attached with a tobacco pipe and tobacco can.

FIG. 7 is an illustration referring to FIG. 6, which the invention is applied to the human mouth.

FIG. 8 is a structural assembly drawing of the present plug invention attached with a flashlight.

FIG. 9 is an exploded view of the present plug invention and flashlight.

FIG. 10 is an assembly section drawing of the present plug invention attached with a flashlight.

FIG. 11 is a structural assembly drawing of the present plug invention attached with a tobacco pipe and flashlight.

### DESCRIPTION OF MAIN COMPONENT SYMBOLS

The reference numerals identify the respective structural elements of the invention:

(Presently available)
1 Paintball gun
11 Barrel
2 Barrel plug
21 Bung

(Present invention)
300 Barrel plug
3 Body
31 Plug
311 Slot
312 O-ring
32 Nozzle
33 Bore
34 Channel
4 Tobacco can
41 Lower base
411 Protruding member
412 Outer thread
42 Cover
421 Stud
422 Internal thread
43 O-ring
5 Tobacco pipe
50 Chamber
51 Stud
52 Through-hole
6 Flashlight
61 Lamp holder
610 Lamp
611 Internal thread
62 Base
620 Protruding member
6201 Outer thread
621 Stud
622 Chamber
623 Spring
624 Battery
7 Tobacco

### DETAILED DESCRIPTION OF THE PREFERRED EMBODIMENTS

The previous description of the present invention and its other technological descriptions, characteristics and performances are described in detail with the drawings of a preferred embodiment. The drawings are for the purpose of illustration only and do not limit the specific ratio and precise layout of the invention. Accordingly, the scope of protection is not limited to the ratio and layout to the embodiment drawings of this present invention.

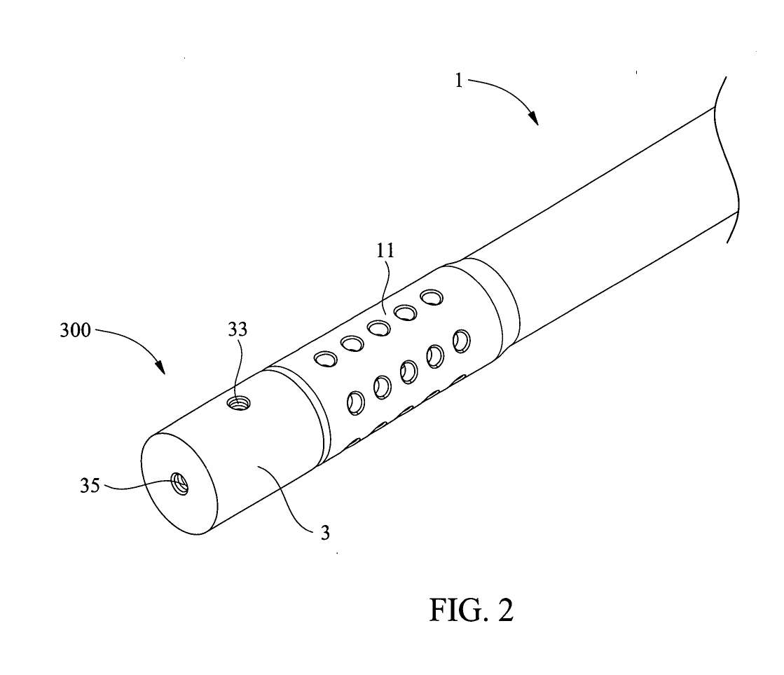

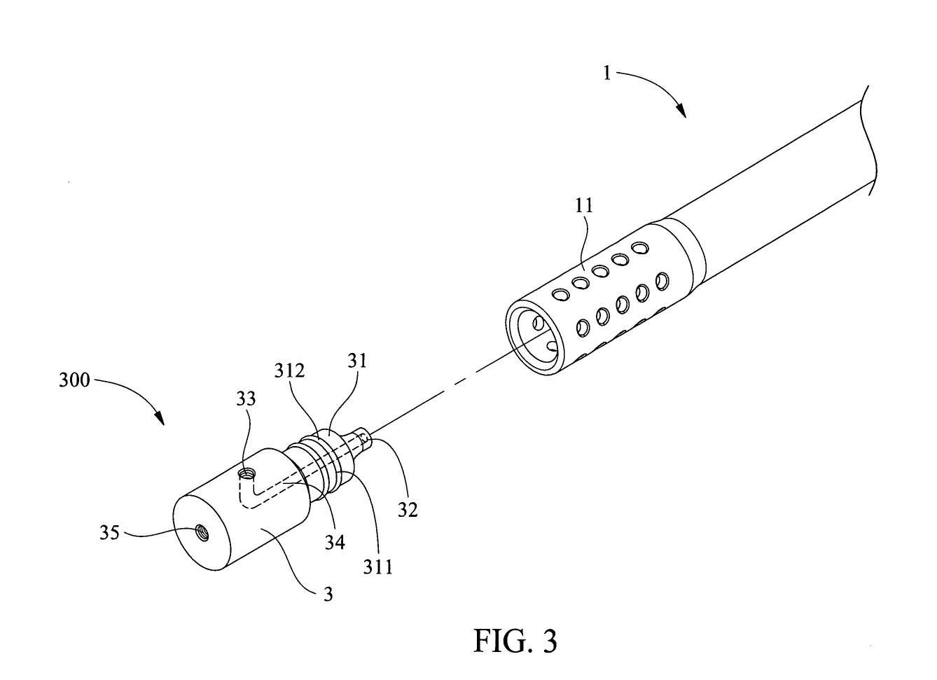

Referring to FIGS. 2 and 3, the exploded view and structural assembly of the multifunctional paintball gun barrel plug structure of this invention, including a barrel plug 300 with the barrel in accordance with a preferred embodiment are shown.

The previous barrel plug 300 includes a body 3, which bores 35, 33 are respectively located on the axial and radial sides of the body 3. At one end of the body 3 includes a plug 31 for plugging the barrel 11 of the paintball gun 1. The upper ring of the plug 31 includes at least one O-ring 312 slot 311, which two slots 311 are two O-rings 312 on the said slots 311 are shown in the preferred embodiment, but do not limit the invention. The number of slots 311 and O-rings 312 can vary, and are within the scope of protection. Furthermore, the invention has a larger application scope than the presently available fixed-single-size plug, wherein the slots 311 are equipped with elastic O-rings 312, and therefore may fit with different sizes of paintball gun 1 barrels 11 if errors in size error and not become waste. In addition, the plug 31 adjacent to the body 3 of the barrel plug 300 includes a nozzle 32, wherein forms a conical shape in the embodiment, but can form various shapes and do not limit the invention. In addition, an airway channel 34 connects the nozzle 32 and bore 33 at the radial side of the body 3 to provide smoking.

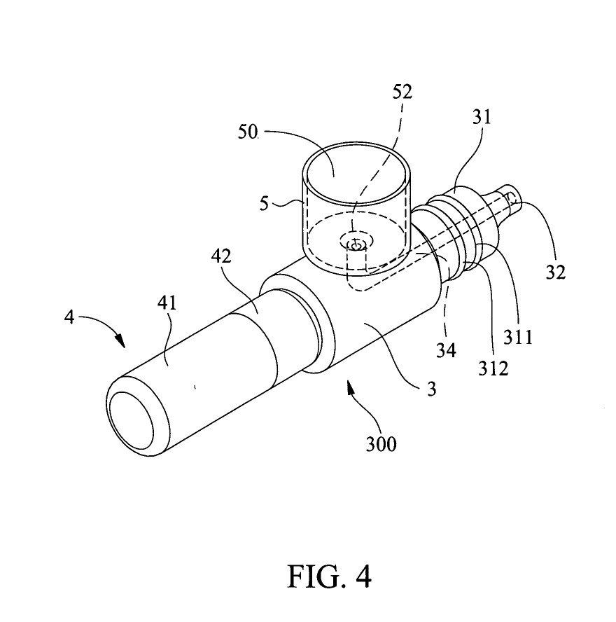

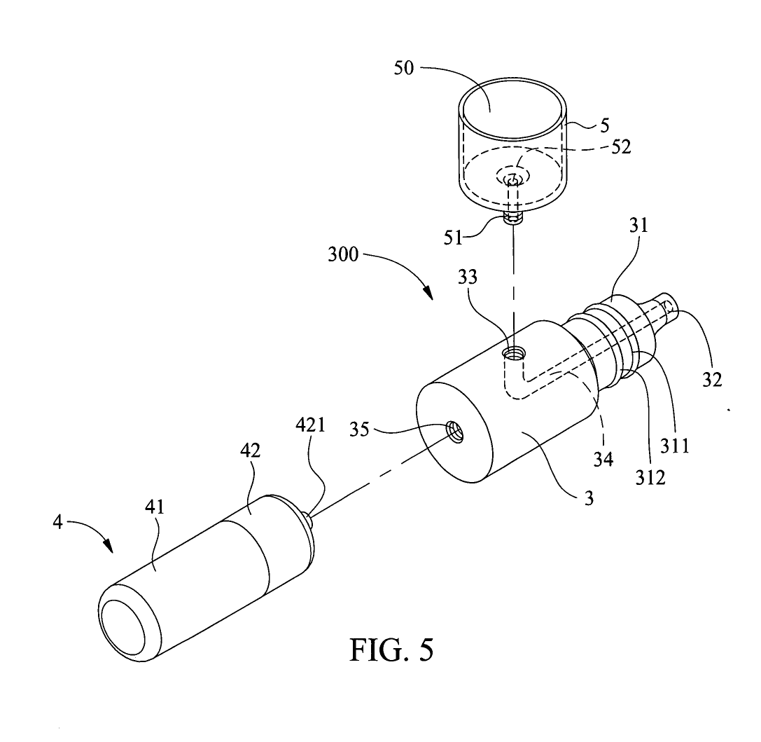

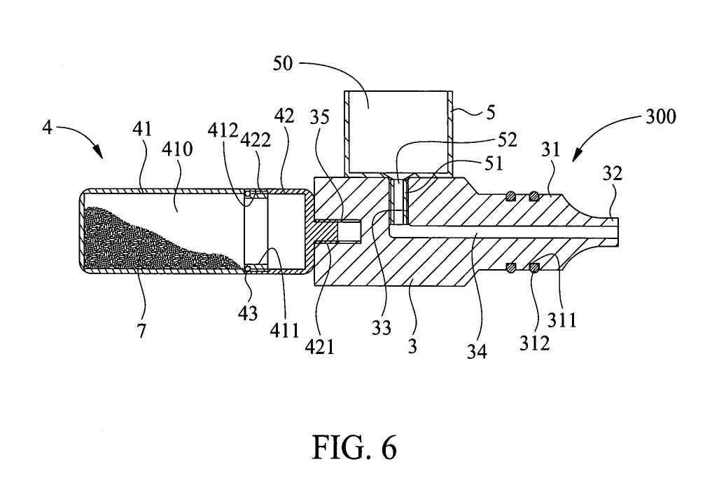

Referring to FIGS. 4, 5, 6 and 7, drawings of the invention with the tobacco pipe and tobacco can by structural assembly, exploded view, assembly section, and drawing of the invention applied for smoking referring to FIG. 6 are shown. Furthermore with the invention, an optional tobacco pipe 5 is located at the bore 33 on the radial side of the barrel plug 300 body 3, which the tobacco pipe 5 includes a chamber 50 for placing and burning tobacco. The chamber 50 in the preferred embodiment is U-shaped, but do not limit the invention, as the said chamber 50 may have different shapes and are within the scope of protection; in addition, beneath the tobacco pipe 5 includes a stud 51 at the bore 33 on the radial side of the barrel plug 300 body 3, which a through-hole 52 inside the stud 51 connects the chamber 50.

The invention preferably includes an optional tobacco can at the bore 35 at the axial side of the body 3 of the barrel plug 300, which includes a lower base 41, a cover 42, and an O-ring 43. The cover 42 is located on top of the lower base 41, and between is an O-ring 43 for sealing purposes for the lower base 41 and cover 42. Furthermore, in order to combine the tobacco can 4 and the body 3 of the barrel plug 300 into a unified object, one end of the cover 42 has a corresponding stud 421 for the bore 35 of the barrel plug 300 body 3 at the axial side, which opens and closes the cover 42 and lower base 41, and also can store tobacco 7. Internal thread 422 is arranged inside the cover 42, and a chamber 410 is included inside the lower base 41. At one end of the said lower base 41 is arranged with a protruding member 411, which corresponds to the outer thread 412 and internal thread 422 of the cover 42, and an O-ring 43 between the lower base 41 and cover 42 is placed at the bottom of the outer thread 412 protruding member 411 of the lower base 41 for close tightening.

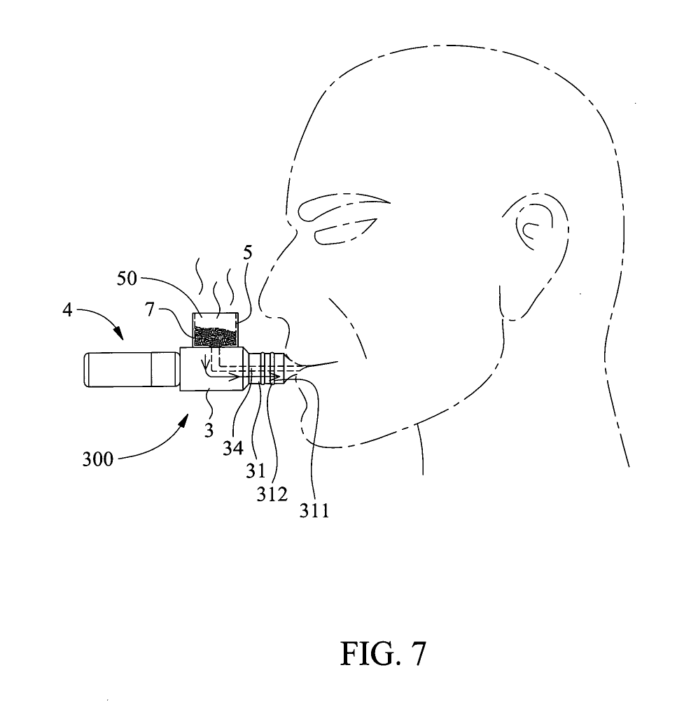

Referring to FIG. 7, the invention can store the tobacco 7 inside the tobacco can 4, located inside the bore 35 at the axial side of the barrel plug 300 body 3. Furthermore, the chamber 50 of the tobacco pipe 5 is located inside the bore 33 at the radial side of the barrel plug 300 body 3. The tobacco pipe 5 and chamber 50 is connected through the through-hole 52 at the stud 51 beneath, and connected to the barrel plug 300 body 3 and nozzle 32 at the radial side bore 33 through the channel 34. Therefore the tobacco 7 placed inside the chamber 50 can be ignited and smoked through the nozzle 32. The replenishing and storage of tobacco 7 by the tobacco can 4 provides convenient accessibility.

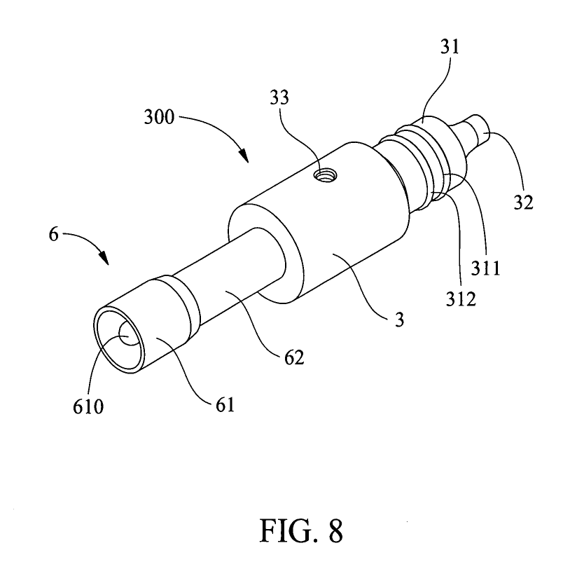

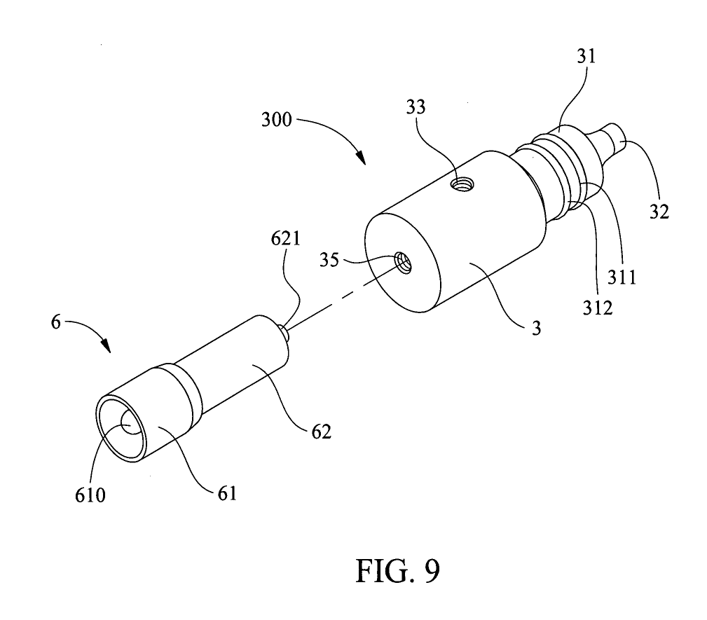

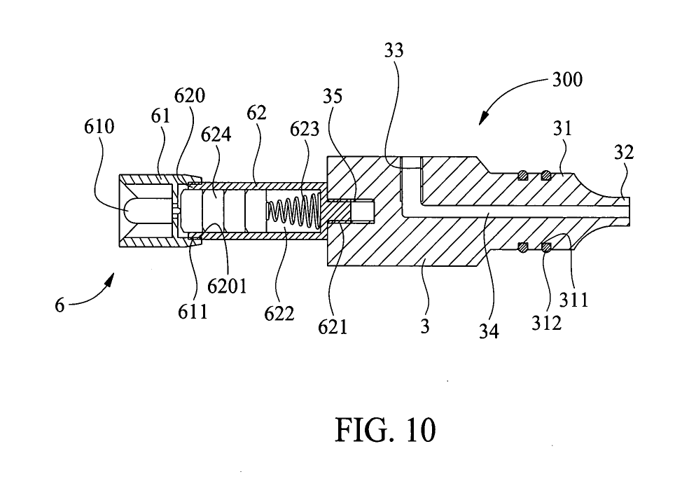

Referring to FIGS. 8, 9 and 10, the structural assembly, exploded view and assembly section of a flashlight with the barrel plug invention are shown. Furthermore with the invention, an optional flashlight 6 is located at the bores 35, 33 on the axial or radial sides of the barrel plug 300 body 3, with said flashlight 6 includes a lamp holder 61 and a base 62, wherein the lamp holder 61 is located on top of the base 62, and a stud 621 is located at the barrel plug 300 of the base 62 end corresponding to the barrel plug bore 35, 33 on the axial or radial side. Furthermore, a lamp 610 is located at one end of the internal thread 611 and inside the lamp holder. In addition, a base 62 is located beneath the lamp holder 61, which inside the said base 62 includes a chamber 622 which provides power supply 624 and conductive spring 623. An outer thread 6201 protruding member 620 corresponds to one end of the said base 62 and lamp holder 61. When used, the lamp holder 61 rotates to either have the negative pole and base 62 located at the internal thread 611 have contact or being released from the protruding member 620, whereas the positive pole of the lamp 610 is pushed by the spring 623 inside the base 62 chamber 622 to make contact with the power supply 624, providing an on-and-off connection with the power source, and having the lamp 610 on the lamp holder 61 to illuminate or turn off.

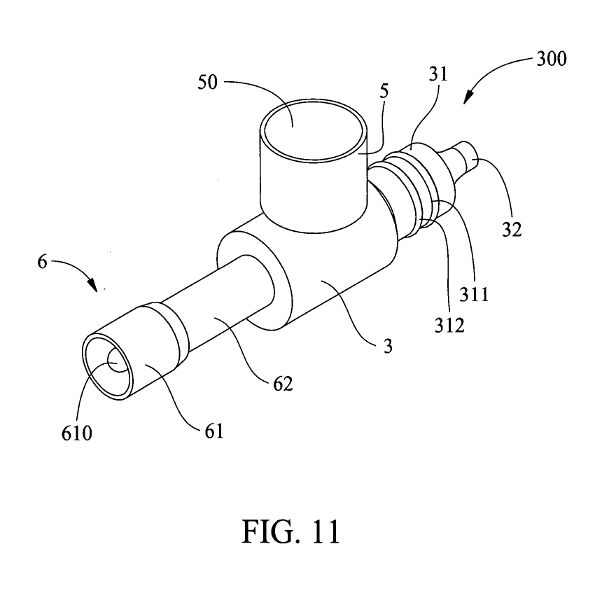

Referring to FIG. 11, the structural assembly of the barrel plug invention with the tobacco pipe and flashlight is shown. In addition to the bore 33 on the radial side of the barrel plug 300 body 3 includes a tobacco pipe 5 for smoking, in FIG. 4 the tobacco can at the bore 35 on the axial side can be replaced with a flashlight 6.

The design of this barrel plug 300 invention not only functions as a safety plug for the paintball gun 1 barrel 11, but also functions as an optional tobacco can 4 to place tobacco 7, and also works as a tobacco pipe 5 and flashlight 6. The invention can effectively broaden the scope of application and increase its convenience, which displays improvement, practical use, and meets with the needs of users.

From the above description, it can be seen that the present invention has truly obtained and enhanced the performance based on past technical structures, which is also easy for those unfamiliar with the ordinary skill in the art to understand. In addition, the present invention has never been announced before this patent application, which the features in improvement and practical use all conform to the conditions for patent application. Therefore this application based on the related regulations to apply for a patent. We hope and show the most gratitude that your most honorable agency may approve the application to encourage continuous inventions.

The description of the above embodiment only describes the technological concept and features of this present invention, which is purposed to enable those familiar with the ordinary skill in the art can understand the contents of this present invention and to implement. The above description is only for the preferred embodiment of the present invention, and should not be limited to the scope of the present invention. Any simple equivalent changes or modifications within the scope of the present invention and description remain to be within the scope of this invention.

What is claimed is:

1. A multifunctional paintball gun barrel plug structure comprising:
a barrel plug, wherein the body of the barrel plug is equipped with bores at its axial and radial sides, with a plug included at the body end and having at least an O-ring slot at the upper ring of the plug, and also a nozzle is included next to the plug, in which a connecting channel exists between the nozzle and the bore on the radial side of the body.

2. The multifunctional paintball gun barrel plug structure according to claim 1, wherein the nozzle of the barrel plug can be of a conical shape.

3. The multifunctional paintball gun barrel plug structure according to claim 1, wherein at the bore on the radial side of the barrel plug body is attached with an optional tobacco pipe, with said tobacco pipe having a chamber, and beneath a stud corresponding to the bore on the radial side of the body, with said stud having a through-hole connecting the chamber.

4. The multifunctional paintball gun barrel plug structure according to claim 3, wherein the chamber of the tobacco pipe is U-shaped.

5. The multifunctional paintball gun barrel plug structure according to claim 3, wherein at the bore on the axial side of the barrel plug body is attached with an optional tobacco can, with said tobacco can including a lower base, a cover, an O-ring, with said cover placed on top of the lower base with an O-ring in between, and a stud at the cover end corresponding to the bore on the axial side of the barrel plug body.

6. The multifunctional paintball gun barrel plug structure according to claim 5, wherein the cover of the tobacco can includes internal thread within, a chamber inside the lower base, and a protruding outer thread corresponding to the internal thread of the cover, which an O-ring is placed at the bottom of the outer thread to tightly secure the cover.

7. The multifunctional paintball gun barrel plug structure according to claim 1, wherein at the bore on the radial or axial side of the barrel plug body is attached with an optional flashlight, said flashlight including a lamp holder and base, which the lamp holder is attached on top of the base, and having a stud at the base end corresponding to the bore on the radial or axial side of the barrel plug.

8. The multifunctional paintball gun barrel plug structure according to claim 7, wherein the lamp holder of the flashlight includes a lamp, with one end attached to the internal thread, and beneath the lamp holder is a base with a chamber, with an end corresponding to the internal thread of said base and lamp holder is a protruding outer thread, and inside the base chamber is a spring and battery to serve as the switch and electricity power for the lamp.

9. The multifunctional paintball gun barrel plug structure according to claim 3, wherein at the bore on the axial side of the barrel plug is attached with an optional flashlight, said flashlight includes a lamp holder and a base, which the lamp holder is placed on top of the base, and a stud is located at the base end corresponding to the bore on the axial side of the barrel plug.

10. The multifunctional paintball gun barrel plug structure according to claim 9, wherein the lamp holder of the flashlight includes a lamp, with one end attached to the internal thread, and beneath the lamp holder is a base with a chamber, with an end corresponding to the internal thread of said base and lamp holder is a protruding outer thread, and inside the base chamber is a spring and battery to serve as the switch and electricity power for the lamp.
